(19) United States
(12) Patent Application Publication
(10) Pub. No.: US 2002/0106188 A1
(43) Pub. Date: Aug. 8, 2002

(54) Apparatus and method for a real time movie editing device

(76) Inventors: Jason Brice Crop, Windsor, CO (US); Tiffany Lyn Crop, Windsor, CO (US)

Correspondence Address: Jason B. Crop, 1009 Meadow Ct, Windsor, CO, 80550, US

(21) Appl. No.: 10/082,325

(22) Filed: Feb. 26, 2002

Related U.S. Application Data
(60) Provisional application No. 60/266,529, filed on Feb. 6, 2001.

(51) Int. Cl. H04N 5/92; G11B 27/00

(52) U.S. Cl. 386/52; 386/55

(57) ABSTRACT

The present invention allows a user to edit out offensive scenes and/or dialogue from any movie by discovering the exact time of the location of the movie. When the exact time of the location of the movie is known, a movie may be edited based on editing data that corresponds to the time in the movie when offensive material occurs. A user downloads a file from the Internet that contains timing and editing data for a movie the user desires to watch. The file is selected based on the amount of editing the user desires. For example, the user may select a reduced rating (similar to a PG rating) for a movie that is rated R in its normal format. After downloading the timing data and editing data file, the user plays the movie by way of any traditional method (VCR, DVD player, cable or satellite TV, or other device) in conjunction with the present invention.

The present invention determines the location of the movie based on a comparison of the audio and/or video inputs from the movie being played and the downloaded timing data. In this manner, the present invention discovers the location of the movie and then uses the editing data to turn off the video output (“blanking”) and/or mute the audio during offensive scenes and/or dialogue.

### CROSS-REFERENCE TO RELATED APPLICATION

This application claims the benefit of U.S. Provisional Application No. 60/266,529, filed on Feb. 6, 2001.

### BACKGROUND OF THE INVENTION

In general, movies contain a certain amount of material offensive to certain viewers. Movies are presently rated by a G, PG, PG-13, R, or NC-17 rating that tries to warn a movie viewer of the amount of offensive material in a movie. Often, a movie viewer would like to watch a certain movie because of its desirable characteristics (like plot or a certain actor/actress), however, because of offensive material (reflected by the movie rating) the movie viewer does not view the movie. Many movie viewers would view a certain movie if it had a lower rating, for example, a PG rating instead of an R rating. Other movie viewers watch a movie with a desirable rating, but would still prefer that a few offensive words and/or scenes were edited out. Also, parents often would like to edit out some offensive scenes and/or dialogue for their children. A method for editing out offensive scenes and/or dialogue is very desirable.

One method for editing movies is for the user to edit out the offensive scenes and dialogue manually. This method requires the user to either cut and tape the video tape, fast-forward or mute the DVD player or video tape player during the offensive scene, or turn off the television and/or mute the volume during offensive scenes if played by way of cable or satellite television. The first method requires the user to purchase the movie in order to edit it. Also, the user is required to view the offensive scenes in order to be able to edit them. The other two methods are ineffective because the user must view and/or listen to the beginning of the offensive material in order to edit the scenes. Also, the user will not know when to return to normal viewing because the user does not know when the offensive material ends. This method is not very desirable and generally not used because of the difficulty of the method.

Another method for censoring movies is to use the closed captioning information available on line 21 of many video signals. This method involves comparing words in the closed caption information with a list of offensive words. If an offensive word is found in the closed captioning, the closed captioning is altered to delete the offensive word and the audio is muted. Because the closed captioning does not always match up exactly with the audio signal, sometimes the audio is not muted at the exact time that the word is actually being spoken in the movie. Some offensive words may still be played for the user even with the censoring device on. Also, the user is not allowed to edit out offensive scenes because that information is not contained in the closed captioning. This method is not very desirable because of the lack of flexibility and the less than 100% accuracy of this method.

A possible solution to the aforementioned problems is to publish a time that the video should be blanked and/or the audio muted because of offensive scenes and/or dialogue. The movie viewer could view the movie and when the movie time displayed on the VCR or DVD player is during an offensive scene or dialogue, the user could turn off the TV or mute the volume. This method may filter out some or most of the offensive material, but a good amount of material will still be played because of the limitations of the method.

First, the time of the movie reflected on the VCR or the DVD player is often not very accurate. Second, the time on the VCR or DVD player is generally only accurate to the second range. Generally, an offensive word or scene will not begin or end right on the second. This means that either some offensive material will not be edited out or non-offensive material will be edited out. Third, this method is limited by the quickness of the user. If the user is not quick enough to mute and/or turn off the TV at the appropriate time, offensive material will be displayed. Last, requiring the user to keep track of time will be a distraction and detract from the movie viewing experience. Thus, there is a need in the art for a device that edits out offensive material based on the movie time with a high degree of accuracy and precision without requiring any effort from the user during the movie.

### BRIEF SUMMARY OF THE INVENTION

The present invention allows a user to edit out offensive scenes and/or dialogue from any movie by discovering the exact time of the location of the movie. When the exact time of the location of the movie is known, a movie may be edited based on editing data that corresponds to the time in the movie when offensive material occurs. A user downloads a file from the Internet that contains timing and editing data for a movie the user desires to watch. The file is selected based on the amount of editing the user desires. For example, the user may select a lower rating for a movie that is rated R in its normal format. After downloading the timing data and editing data file, the user plays the movie by way of any traditional method (VCR, DVD player, cable or satellite TV, or other device) in conjunction with the present invention.

The present invention determines the location of the movie based on a comparison of the audio and/or video inputs from the movie being played and the downloaded timing data. In this manner, the present invention discovers the location of the movie and then uses the editing data to turn off the video output (“blanking”) and/or mute the audio during offensive scenes and/or dialogue.

It is an advantage of the present invention to provide a device that allows a user to view a movie with offensive scenes and/or dialogue edited out without requiring the user to expend any effort during movie viewing.

It is a further advantage of the present invention to provide an editing device that uses the audio and/or video signal from a movie to edit out offensive scenes and/or dialogue with an extremely high degree of accuracy.

It is a further advantage of the present invention to provide an editing device that functions with any type of device that has an audio/video output independent of the speed at which the device plays the movie.

### BRIEF DESCRIPTION OF THE DRAWINGS

The previously stated and other advantages of the present invention will be more readily ascertainable with a description of a preferred embodiment in conjunction with the following drawings.

FIG. 1 is a block diagram of the present invention.

FIG. 2 is a more detailed block diagram of a real time editing device and its components.

FIG. 3 is an example of a portion of typical timing data.

FIG. 4 is an alternative embodiment of the present invention.

### DETAILED DESCRIPTION OF THE INVENTION

While the invention is susceptible to various modifications and alternative forms, specific embodiments thereof have been shown by way of example in the drawings and will herein be described in detail. It should be understood, however, that the detailed description is not intended to limit the invention to the particular forms disclosed. On the contrary, the intention is to cover all modifications, equivalents, and alternatives falling within the spirit and scope of the invention as defined by the appended claims.

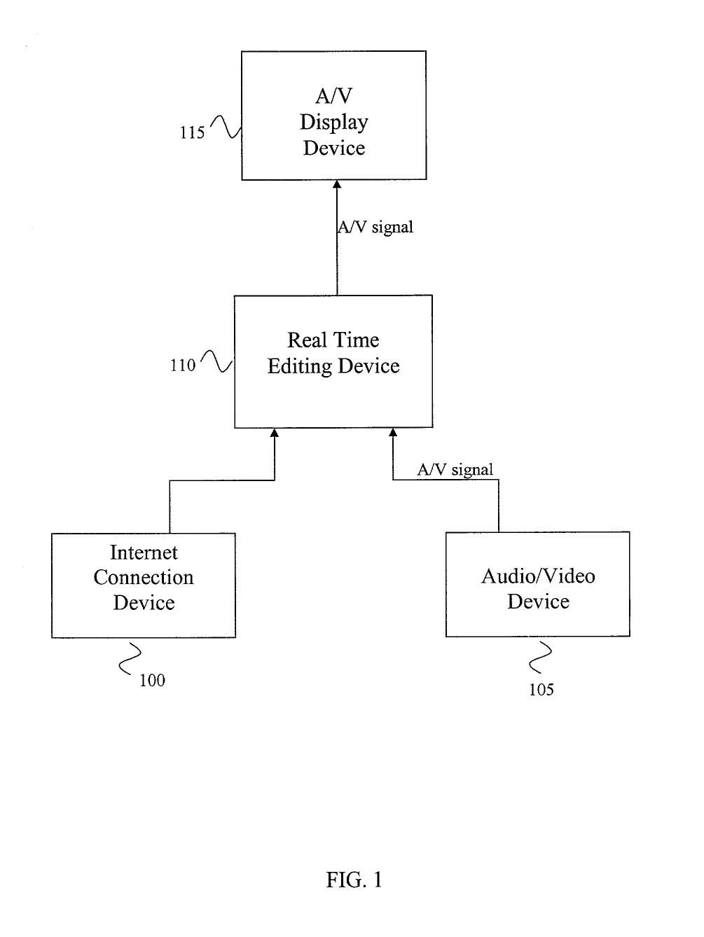

FIG. 1 is an illustration of the preferred embodiment of the present invention. Audio/video outputs from an audio/video device 105 are connected to a real time editing device 110. The audio/video device 105 maybe a DVD player, VCR, satellite or cable TV decoder, WebTV, or any other device that produces an audio/video output. The real time editing device 110 is also connected to an audio/video display device 115 and an Internet connection device 100. Typically, the audio/video display device 115 is a television set, however any device with audio/video inputs may be used. Optionally, the audio/video playing device 115 may include a stereo or surround sound system that only receives an audio input from the real time editing device 110. The Internet connection device 100 usually is a computer, webTV, or other device that is connected by the Internet to the world wide web.

Often, a movie viewer desires to watch a certain movie, but because of offensive scenes or dialogue the user will not view the movie. The present invention allows a user to edit out unwanted scenes or dialogue during real time viewing without physically altering the movie. First, the user selects the desired movie, either by renting the video cassette or DVD, receiving the movie over satellite, cable TV, or through the Internet, or by some other means. Before the movie is shown, the user uses the Internet connection device 100 to access a website that contains editing and timing data for the desired movie. Typically the user will be able to select a certain amount of editing. For example, if the movie is rated R, the user will be able to select editing data for a lower rated (similar to a PG rating) version of the movie. Obviously, other means of classifying an amount or type of editing done may be used, however the method stated is one familiar to most people. The timing data and the desired version of the editing data is downloaded to the Internet connection device 100 then transferred to the real time editing device 110.

The editing data contains the locations in the movie where offensive scenes should be blanked and/or the audio output should be muted. When the user plays the movie by way of the audio/video device 105, the real time editing device 110 first uses the timing data to synchronize with the movie. Once synchronization occurs, the real time editing device 110 compares the location of the movie to the editing data and mutes the audio signal and/or blanks the video signal to the audio/video display device 115 in the appropriate locations of the movie. Thus the real time editing device allows the user to view the desired movie without needing to view unwanted scenes or hear unwanted dialogue.

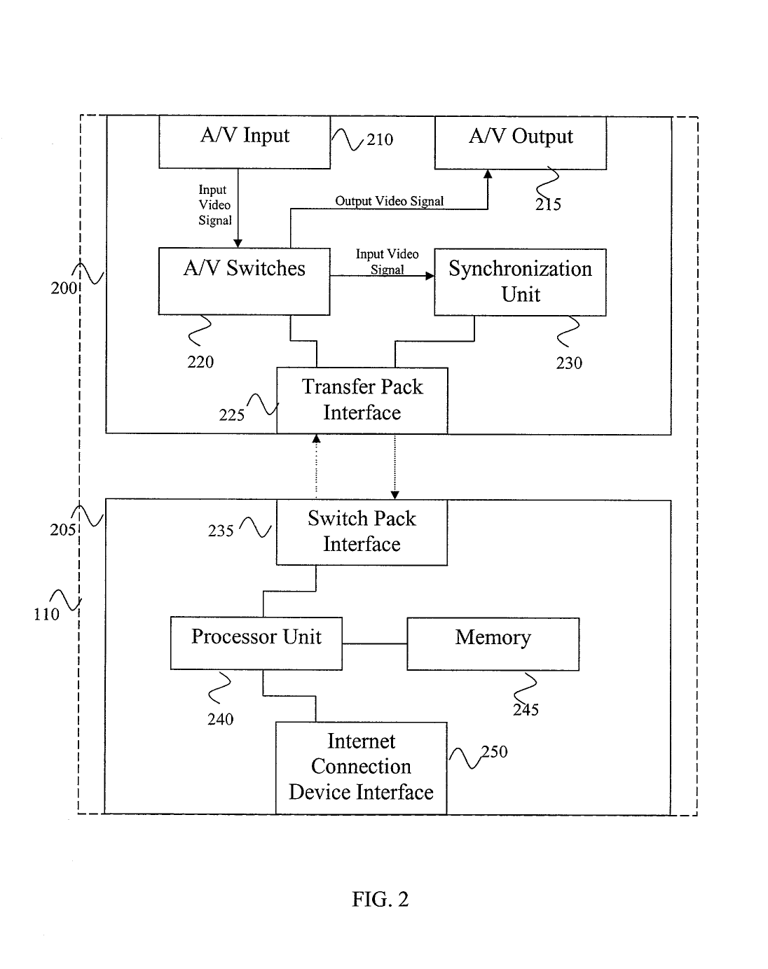

A more detailed description of the real time editing device 110, as illustrated in FIG. 2, will better describe the preferred embodiment of the present invention. The real time editing device 110 comprises two parts: a switch pack 200 and a transfer pack 205. Typically, a user has the audio/video display device 115 and the audio/video device 105 near each other, but the Internet connection device 100 is far apart or in a separate location. Having two parts to the real time editing device allows the user to leave the switch pack 200 connected to the audio/video display device 115 and the audio/video device 105 while the transfer pack 205 is taken to the Internet connection device 100 in the other location. The transfer pack 205 is easily disconnected from the Internet connection device 100 and reconnected to the switch pack 200 without needing to reconnect any wires from any other devices.

The switch pack 200 comprises: an audio/video input 210, audio/video output 215, audio/video switches 220, synchronization unit 230, and a transfer pack interface 225. The transfer pack 205 comprises: a processor unit 240, memory 245, switch pack interface 235, and an Internet connection device interface 250. When the user desires to edit out unwanted parts of a movie, the user connects the transfer pack 205 to the Internet connection device 100 by way of the Internet connection device interface 250. The user selects the desired editing and timing data as previously described and downloads it to the Internet connection device 100. The editing data contains information of the exact time that the audio/video display device 115 should be blanked and when the audio should be muted, and the duration of the blanking or muting. These times are then loaded and stored in the memory 245 (preferably static random access memory or any other memory component capable of reading and writing data) by the processor unit 240.

After the transfer is complete, the user disconnects the transfer pack 205 from the Internet connection device 100 and connects the transfer pack 205 to the switch pack 200. The processor unit 240 is then connected to the audio/video switches 220 and synchronization unit 230 by way of the switch pack interface 235 and transfer pack interface 225. The audio/video switches 220 (or any other device capable of switching) are connected to the synchronization unit 230, audio/video device 105 by way of the audio/video input 210, and the audio/video display device 115 by way of the audio/video output 215.

In the preferred embodiment of the present invention, the closed captioning component of the input video signal is used for synchronizing the real time editing device 110 with the input video signal from the audio/video device 105. The timing data contains a compilation of the number of ASCII characters in each closed captioning sentence of the entire movie. Also, the timing data contains the time (within 1/60^{th} of a second) associated with the number of ASCII characters of each closed captioning sentence. Generating the timing data comprises starting a movie at the same time a clock is reset. When a closed captioning sentence ends, line 21 of the video signal contains seven low bits and a high parity bit. When this bit sequence is received, the end of the closed captioning sentence is reached. The number of ASCII characters in the sentence is counted and stored along with the time (taken from the clock) the parity bit was received. The time at the end of each closed captioning sentence can be used as a time mark in order to map out the entire movie for editing purposes. This method is advantageous because the closed captioning sentence does not need to be decoded which would require more processor cycles.

For example, if the first line 21 closed captioning sentence of the movie is “It was love at first sight”, the first value stored in the timing data portion of the memory 245 will be 26 (excluding header and ending bits). If the end of the closed captioning sentence occurred at zero hours, zero minutes, 2 seconds, and 25/60ths of a second (based on the clock), this value will be stored along with the number of ASCII characters in the sentence (26). The second memory location in the timing data will contain the number of ASCII characters in the second closed captioning sentence along with its associated time. The rest of the timing data continues the same pattern for the entire movie.

In order to synchronize with a movie being played by the audio/video device 105, the real time editing device 110 first determines the number of ASCII characters from the closed captioning portion of the input video signal from the audio/video device 105. To accomplish this, the synchronization unit 230 receives the input video signal from the audio/video switches 220 and sends an interrupt to the processor unit 240 during every vertical blanking period. After a period of time, the processor unit 240 samples the output of the synchronization unit 230 during line 21 of the input video signal. The processor unit 240 increments a counter each time a character is detected. The processor unit 240 detects the end of the sentence when the seven low bits and one high parity bit are received. The counter contains a first number that represents the number of ASCII characters from the first closed captioning sentence received from the input video signal. The processor unit 240 then compares the first number to the timing data stored in memory 245.

The processor unit 240 begins comparing the first number to the value found at the first line of the timing data stored in the memory 245. If the first number does not equal the value in the first memory location of the timing data, a match is not found and the processor unit 240 continues on comparing at the next memory location until a match is found. When a match is found, the processor unit 240 gets a second number that represents the number of ASCII characters from the second closed captioning sentence received from the input video signal. The processor unit 240 compares the second number to the value found in the memory location following the first matching location. If the value is the same, the processor unit 240 continues the same process until four matches are found.

If one of the numbers does not match up, the processor unit 240 skips to the next memory location following the first matching location and compares the first number to the value stored. The process then continues as previously described until four matches are made.

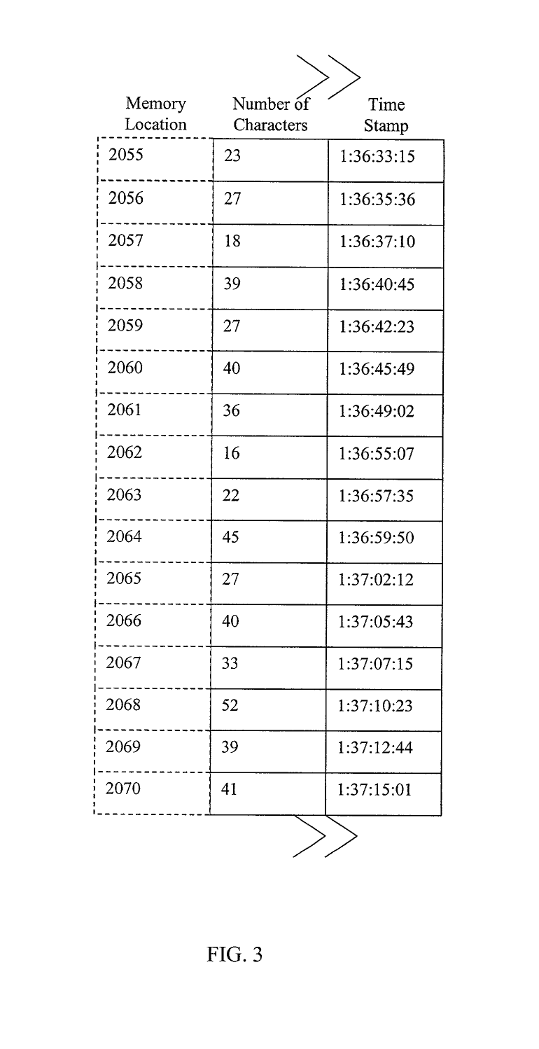

An example of the matching process is illustrated in FIG. 3. Here, typical timing data is illustrated in the memory. The memory location is labeled for ease of reference for this example, but is not necessarily contained in memory. Each memory location number corresponds to every closed captioning sentence of the entire movie. For example, the first memory location contains the data corresponding to the first closed captioning sentence of the movie. The first column of memory contains the number of ASCII characters found in the corresponding closed captioning sentence. The second column of memory contains the time stamp associated with the same closed captioning sentence. In this example, memory location 2055 (or in other words, the 2055^{th} closed captioning sentence) contains 23 ASCII characters and the sentence ended at 1 hour, 36 minutes, 33 seconds, and 15/60ths of a second from the beginning of the movie.

If the user begins a movie at an arbitrary location, the real time editing device 110 begins the synchronization process by comparing the number of ASCII characters found in the first closed captioning sentence received from the input video signal to the number of characters found in the first memory location. In this example, the first closed captioning sentence received contains 27 ASCII characters. After comparing 27 to all of the previous memory locations, the processor unit 240 finds a match at memory location 2056. In this example, the next closed captioning sentence received from the input video signal has 40 ASCII characters. The processor unit 240 compares 40 with the number of characters found in memory location 2057. Since memory location 2057 contains the number 18, a match is not made.

The processor unit 240 then starts over by comparing 40 to the number of characters found in memory location 2057. A match is not made until memory location 2059. The processor unit 240 then compares the second closed captioning sentence number of characters to memory location 2060. A match is made because the location contains the number 40. In this example, the third closed captioning sentence contains 33 ASCII characters. The processor unit 240 compares 33 to the next number of characters found in memory location 2061. A match is not made, so the processor unit 240 begins comparing the number of ASCII characters from the first closed captioning sentence at memory location 2060.

A match is not made until memory location 2065. The processor unit 240 compares the number of ASCII characters in the second closed captioning sentence to the number of characters found in memory location 2066 and finds a match. The processor unit 240 also finds a match between the number of characters in memory location 2067 and the number of characters in the third closed captioning sentence. In this example, the fourth closed captioning sentence contains 52 ASCII characters. The processor unit 240 compares 52 to the number of characters found in memory location 2068. A match is made and the synchronization process is complete because four matches in a row are made.

In general, requiring four matches will ensure that the real time editing device 110 is synchronized with the movie, although requiring more or less can be done according to the accuracy desired. This method of synchronization is advantageous because no matter where the user begins viewing a movie, the real time editing device 110 will synchronize with the movie location. Typically, the real time editing device 110 will need to resynchronize with the input video signal often in case the user fast-forwards, rewinds, or pauses the movie. Also, re-synchronization takes place because different audio/video devices 105 play the movie faster or slower than others. Re-synchronization ensures that the real-time editing device will not miss an offensive scene and/or dialogue.

After four matches are made, the processor unit 240 restarts a clock with the value contained in the timing mark location of the fourth matching location. In this example, the clock is reset to a value of 1 hour, 37 minutes, 10 seconds, and 23/60ths of a second. The clock proceeds to keep track of time and the editing process is initiated.

In the preferred embodiment of the present invention, the editing data contains the times when the audio should be muted and/or the video blanked and the times that the audio and/or video should return to normal viewing. After synchronization is complete and the clock is running, the processor unit 240 checks the editing data to determine if the audio and/or video should be turned off. The processor unit 240 compares the movie time present on the clock with the times stored in the editing data. If the time present on the clock is greater than the time the audio should be muted and less than the time the audio should be returned to normal, the processor unit 240 causes the audio/video switches 220 to turn off the audio output to the audio/video display device 115 until the clock is greater than or equal to the time the audio should return to normal listening. If the time present on the clock is greater than the time the video should be blanked and less than the time the video should be returned to normal, the processor unit 240 causes the audio/video switches 220 to turn off the video output to the audio/video display device 115 until the clock is equal to/greater than the time the video should return to normal viewing. In this manner, the present invention edits out offensive scenes and/or dialogue even if the movie is started in the middle of an offensive scene and/or dialogue.

Editing data is compiled based on what scenes and/or dialogue should be edited out to achieve a certain rating for a movie. Alternative forms of editing data could be made available based on what types of words and/or scenes a user finds offensive. Since the editing data is accurate to 1/60^{th} of a second, the present invention allows for a very high degree of accuracy of editing out offensive scenes and/or dialogue. A compiler of the editing data can watch the movie with the editing data to verify that the video and/or audio is turned off at exactly the right location. If not, the compiler of the editing data can change the editing data to achieve 100% accuracy in the deletion of offensive scenes and/or dialogue. Thus, the present invention will not allow an unwanted scene and/or dialogue to be played, thereby overcoming the previously discussed accuracy limitations of the prior art.

When the transfer pack 205 is disconnected, there is no movie information loaded into memory 245, or the transfer pack 205 is off the audio/video switches 220 connect any input signal from the audio/video input 210 to the audio/video output 215. In this manner, when the real time editing device 110 is not in active mode, the user continues normal viewing without needing to connect or disconnect any wires. Any input audio/video signal (from a VCR, DVD player, cable TV or satellite TV, or other audio/video input) will proceed unchanged and unedited through the real time editing device 110 to the audio/video display device 115.

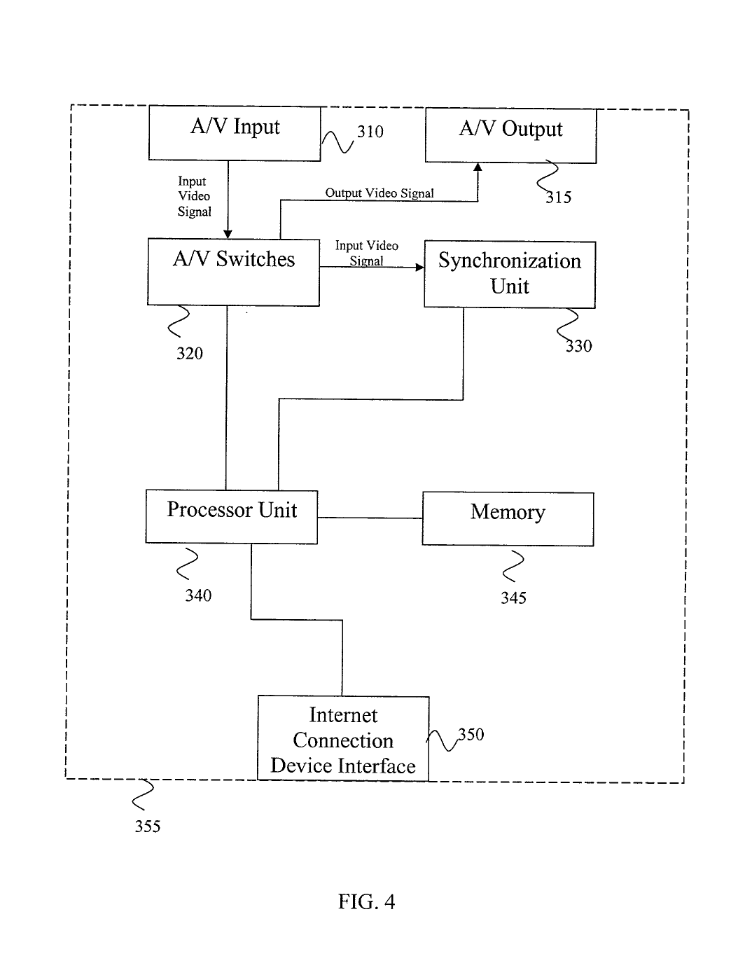

An alternative embodiment of the present invention is illustrated in FIG. 4. Here, a real time editing device 355 comprises many of the same components as the real time editing device 110 of FIG. 2, however, the real time editing device 310 is not split into a transfer pack and switch pack. Some movie viewers have the Internet connection device 100 located nearby the audio/video display device 115 and the audio/video device 105. In this situation, the real time editing device 355 remains connected to the audio/video display device 115 by way of an audio/video output 315, Internet connection device 100 by way of an Internet connection device interface 350, and to the audio/video device 105 by way of an audio/video input 310.

The alternative embodiment functions in the same manner as the preferred embodiment. Editing and timing data is downloaded onto the Internet connection device 100. The processor unit 340 then transfers the editing and timing data from the internet connection device 100 (by way of the Internet connection interface 350) to the memory 345. When the desired movie is played, the real time editing device 355 synchronizes itself with the movie in the manner previously described. Offensive scenes are blanked out and offensive dialogue is muted in accordance with the editing data stored in memory 345, as previously described. Thus, the user is allowed to use the present invention without needing to detach a transfer pack from a switch pack in order to download the editing and timing data.

An alternative embodiment of the present invention samples the audio input from the audio/video device 105 in order to synchronize with the movie. This embodiment may be used if closed captioning information is not available. In this embodiment, the timing data contains the values assigned to the audio input for the entire movie. When the movie is played, the present invention samples and digitizes the audio and compares the value with those stored in the timing data. This method is as accurate as the preferred embodiment, however it requires much more memory and more processor cycles based on the accuracy desired. A similar method may be implemented using the video signal instead of the audio signal.

Other modifications to the present invention may be made. One modification is to make the switch pack 200 and the transfer pack 205 communicate by way of a wireless connection. This would allow the transfer pack 205 to remain with the Internet connection device 100 and the switch pack 200 to remain with the audio/video display device 115 and the audio/video device 105.

Another modification is to include the present invention inside a VCR, DVD player, or cable TV, satellite TV, Internet connection device, or WebTV decoder. In this case, the present invention could be modified to include information for a VCR of DVD player to fast-forward to the end of an offensive scene while blanking the screen.

Another modification is to store in the timing data the ASCII characters for each closed captioning sentence instead of the number of ASCII characters in each sentence. This method would require the real time editing device to decode each ASCII character of each closed captioning sentence and compare the sentence with the sentences stored in memory. This is not very efficient because it requires more memory and more processor cycles for the comparison. Other modifications are possible that fall within the spirit and scope of the present invention.

Also, the present invention could be modified to allow a user to select a desired rating level for all movies viewed. When a movie is played, the present invention could have a connection (either a direct connection over a phone line or a connection through the Internet) to a database containing all of the editing and timing files for all movies available. The present invention would then download the pertinent file (if it is available) to the real time editing device. The present invention would then edit out offensive material as previously described.

Other modifications and improvements will occur to those skilled in the art upon a reading of the foregoing description. It should be understood that all such modifications and improvements have been deleted herein for the sake of conciseness and readability but are properly within the scope of the following claims. Thus, the corresponding structures, materials, acts, and equivalents of all means or step plus function elements in the claims are intended to include any structure, material, or acts for performing the functions in combination with other elements as specifically claimed.

What is claimed is:

1. A real time editing system comprising:
a real time editing device;
a data transfer device in electrical communication with the real time editing device; and
an audio/video device in electrical communication with the real time editing device;
wherein,
the real time editing device receives data from the data transfer device;
the audio/video device transmits a signal to the real time editing device corresponding to an audiovisual work being played on the audio/video device;
the real time editing device determines the location of the audiovisual work; and
the real time editing device edits the signal based on the received data and the location of the audiovisual work and transmits the edited signal to an audio/video display device.

2. The real time editing system as in claim 1, wherein the real time editing device comprises:
a processor unit;
memory in electrical communication with the processor unit; and
a synchronization unit in electrical communication with the processor unit;
wherein,
the processor unit stores the received data in the memory;
the synchronization unit derives a timing mark from the signal;
the processor unit determines the location of the audiovisual work based on a comparison of the timing mark and the received data; and
the processor unit edits the signal based on the received data and the location of the audiovisual work.

3. The real time editing system as in claim 2, wherein the received data contains timing data and editing data.

4. The real time editing system as in claim 3, wherein the processor unit compares the timing data with the timing mark to determine the location of the audiovisual work and edits the signal based on the location of the audiovisual work and the editing data.

5. The real time editing system as in claim 4, wherein the synchronization unit derives the timing mark based on a closed captioning component of the signal.

6. The real time editing system as in claim 5, wherein the timing mark is derived based on the number of ASCII characters in a closed captioning sentence of the signal.

7. The real time editing system as in claim 6, wherein the timing data contains the number of ASCII characters in each closed captioning sentence for the entire audiovisual work with a corresponding time stamp.

8. The real time editing system as in claim 7, wherein the processor unit:
determines the location of the audiovisual work by comparing the timing data with the timing mark;
starts a clock with the initial value set to the corresponding time stamp value when a match is found; and
edits the signal based on a comparison of the editing data and the clock time.

9. The real time editing system as in claim 2, wherein the real time editing device further comprises:
a switch in electrical communication with the processor unit and the synchronization unit;
wherein the processor unit edits the signal by controlling the switch and the audio/video display device receives the edited signal by way of the switch.

10. The real time editing system as in claim 1, wherein the data transfer device is an internet connection device and the received data is data downloaded from the internet.

11. The real time editing system as in claim 1, wherein the real time editing device is included in the audio/video device.

12. The real time editing system as in claim 1, wherein the real time editing device causes the audio/video device to fast forward the audiovisual work during an offensive scene.

13. The real time editing system as in claim 1, wherein the operations performed by the real time editing device are performed by a multi-purpose processor within the data transfer device.

14. A method for real time audio/video signal editing comprising:
receiving data corresponding to an audiovisual work;
receiving a signal that represents the audiovisual work;
determining the location of the audiovisual work; and
editing the signal based on the received data and location of the audiovisual work.

15. The method for real time audio/video signal editing as in claim 14, wherein receiving data corresponding to an audiovisual work comprises:
downloading the data from a remote location.

16. The method for real time audio/video signal editing as in claim 15, wherein the data is downloaded by way of the internet.

17. The method for real time audio/video signal editing as in claim 14, wherein the data comprises editing data and timing data.

18. The method for real time audio/video signal editing as in claim 17, further comprising:
determining the location of the audiovisual work based on a comparison of the timing data with the received signal; and
editing the signal based on the editing data and the location of the audiovisual work.

19. The method for real time audio/video signal editing as in claim 18, wherein determining the location of the audiovisual work based on a comparison of the timing data with the received signal further comprises:
deriving a timing mark from the signal;
deriving a time stamp from a comparison of the timing data with the timing mark; and
setting a clock with the value of the time stamp.

20. The method for real time audio/video signal editing as in claim 19, wherein the timing mark is derived from a closed captioning component of the received signal.

21. A real time editing apparatus comprising:
a processor unit which receives a signal that represents an audiovisual work; and
memory in electrical communication with the processor unit;
wherein,
the processor unit receives data corresponding to the audiovisual work, stores the data in memory, determines the location of the audiovisual work, and edits the signal based on the stored data and the location of the audiovisual work.

22. The real time editing apparatus as in claim 21, further comprising:
a synchronization unit in electrical communication with the processor unit;
wherein,
the synchronization unit receives the signal that represents the audiovisual work and derives a timing mark from the signal; and
the processor unit determines the location of the audiovisual work based on the timing mark and the stored data.

23. The real time editing apparatus as in claim 22, wherein the stored data comprises editing data and timing data.

24. The real time editing apparatus as in claim 23, wherein the synchronization unit derives the timing mark based on a closed captioning component of the signal.

25. The real time editing apparatus as in claim 24, wherein the timing mark is derived based on the number of ASCII characters in a closed captioning sentence of the signal.

26. The real time editing apparatus as in claim 25, wherein the timing data contains the number of ASCII characters in each closed captioning sentence for the entire audiovisual work with a corresponding time stamp.

27. The real time editing apparatus as in claim 26, wherein the processor unit:
determines the location of the audiovisual work by comparing the timing data with the timing mark;
starts a clock with the initial value set to the corresponding time stamp value when a match is found; and
edits the signal based on a comparison of the editing data and the clock time.

28. The real time editing apparatus as in claim 22, further comprising:
a switch in electrical communication with the processor unit and the synchronization unit;
wherein the processor unit edits the signal by controlling the switch and an audio/video display device receives the edited signal by way of the switch.

29. The real time editing apparatus as in claim 28, wherein the processor unit and the memory are contained in a transfer pack and the switch and the synchronization unit are contained in a switch pack.
